(19) United States
(12) Patent Application Publication
(10) Pub. No.: US 2008/0235907 A1
(43) Pub. Date: Oct. 2, 2008

(54) MULTI-FUNCTIONAL HINGE

(75) Inventors: Michael J. Wayman, Waconia, MN (US); Gregory Martell, Chanhassen, MN (US)

Correspondence Address: FOGG & POWERS LLC, 10 SOUTH FIFTH STREET, SUITE 1000, MINNEAPOLIS, MN, 55402, US

(73) Assignee: ADC TELECOMMUNICATIONS, INC., Eden Prairie, MN (US)

(21) Appl. No.: 11/691,963

(22) Filed: Mar. 27, 2007

(51) Int. Cl. E05D 15/06

(52) U.S. Cl. 16/361

(57) ABSTRACT

A multifunctional hinge is provided. In one embodiment, a device for coupling a panel relative to frame is provided. The device comprises a first body including an elongated cylindrical cavity; and a second body including a shaft having a tab extending from a lateral portion the shaft, the shaft having an axis of rotation about the center of the shaft. The first body is configured to accept insertion of the shaft of the second body into the elongated cylindrical cavity and further configured to allow movement of the second body about the axis of rotation. The first body further includes a slot connected to the elongated cylindrical cavity and configured to allow the tab of the second body to slide therethrough when the second body is rotated.

### CROSS REFERENCE TO RELATED APPLICATIONS

This application is related to U.S. patent application Ser. No. ______ (Attorney Docket No. 100.840US01) having a title of “MODULARIZED RF BAND COMPONENTS ON REMOVABLE DOORS” (also referred to here as the 840 Application), U.S. patent application Ser. No. ______ (Attorney Docket No. 100.834US01) having a title of “CLAMSHELL CHASSIS ASSEMBLY” (also referred to here as the 834 Application), and U.S. patent application Ser. No. ______ (Attorney Docket No. 100.839US01) having a title of “APPARATUS FOR IMPROVING THE ACCESSIBILITY OF A MOUNTED STRUCTURE” (also referred to here as the 839 Application), each of which are filed on even date herewith. The 840, 834, and 839 Applications are hereby incorporated herein by reference.

### BACKGROUND

A common hinge for opening and closing a door generally consists of a two components, one component attaches to the frame and the other component attaches to the door. The two components fit together in such a way that an axis is formed allowing one component to pivot about the axis relative to the other component. Often, each component has a number of loops. The loops of the two components are aligned and a pin is placed through the loops forming the axis of rotation. When one or multiple hinges are aligned along a side of the door, the rotational axes of each hinge align to define a single rotational axis for the door. The door, therefore, is allowed to pivot open and closed relative to the frame.

While this may work fine for everyday doors, the common hinge has many functional limitations which make its application difficult in other situations, such as electronics enclosures or access panels. First, the common hinge does not permit any movement of the door other than pivoting on the hinge axis. This limits the functionality of the door and the accessibility of the opening. For example, outdoor electronics enclosures often have a rubber o-ring or a gasket placed between the door and its frame that helps to seal the door to the frame. Using a common hinge in this situation can cause the gasket to be pinched between the door and the frame when the door is opened. This damages the gasket, reducing its effectiveness and lifetime. Second, once assembled, a door with a common hinge is difficult to separate from the frame. This makes it more difficult to repair, replace, or install all or part of the door. Third, the common hinge does not provide for any restriction in the pivoting motion of the door. This allows the door to swing freely which, in certain environments, can cause injury or damage to nearby people or structures.

For the reasons stated above, and for other reasons stated below which will become apparent to those skilled in the art upon reading and understanding the present specification, there is a need in the art for a hinge with functionality in addition to pivoting.

### SUMMARY

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, a device for coupling a panel relative to frame is provided. The device comprises a first body including an elongated cylindrical cavity; and a second body including a shaft having a tab extending from a lateral portion the shaft, the shaft having an axis of rotation about the center of the shaft. The first body is configured to accept insertion of the shaft of the second body into the elongated cylindrical cavity and further configured to allow movement of the second body about the axis of rotation. The first body further includes a slot connected to the elongated cylindrical cavity and configured to allow the tab of the second body to slide therethrough when the second body is rotated.

### BRIEF DESCRIPTION OF THE DRAWINGS

The present invention can be more easily understood, and further advantages and uses thereof are more readily apparent, when considered in view of the detailed description and the following figures in which:

FIG. 1 is perspective view of a hinge of one embodiment of the present invention;

FIG. 2A is a perspective view the hinge of FIG. 1 of one embodiment of the present invention mounted to an enclosure;

FIG. 2B is an enlarged perspective view of one embodiment of the hinge and enclosure of FIG. 2A;

FIG. 3 is a perspective view of the hinge of one embodiment of the present invention and enclosure of FIGS. 2A and 2B showing a door open and locked;

FIG. 4 is a top view of one embodiment of a female body of the hinge of FIG. 1 of one embodiment of the present invention;

FIG. 5A is a perspective view of the hinge of one embodiment of the present invention and enclosure of FIGS. 2A and 2B showing the door closed and unlatched;

FIG. 5B is a close-up view of the hinge of one embodiment of the present invention and enclosure of FIG. 5A;

FIG. 6 is a perspective view of the hinge of one embodiment of the present invention and enclosure of FIGS. 2A and 2B showing the door closed and latched; and

FIG. 7 is an exploded perspective view of a hinge of one embodiment of the present invention.

In accordance with common practice, the various described features are not drawn to scale but are drawn to emphasize specific features relevant to the present invention. Like reference characters denote like elements throughout the Figures and text.

### DETAILED DESCRIPTION

In the following detailed description, reference is made to the accompanying drawings that form a part hereof, and in which is shown by way of illustration specific illustrative embodiments in which the method and system may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention provide a hinge that increases the functionality and usability of a door relative to hinges available in the art today. The hinge allows the door to rotate about a pivot axis of the hinge, and prevents the door from over-rotation. A tab and notch (or multiple notches) allows the door to be held open at any angle and by lifting the door slightly upward, the tab and notch release allowing for free travel again. This also allows a user to secure the door in an open position for hands-free access to nearby components with the door open. Additionally, the hinge allows the door to be easily removed from the frame, while limiting any inadvertent disconnection. Finally, in addition to rotation, the door is allowed to slide laterally away from the frame. This allows the door, prior to rotation, to release pressure on a rubber gasket or the like used to seal the door. Any contact between the moving door and the stationary gasket is thereby reduced, increasing the longevity of the gasket. Additionally, embodiments of the hinge allow for inexpensive construction as they are mostly die-castable.

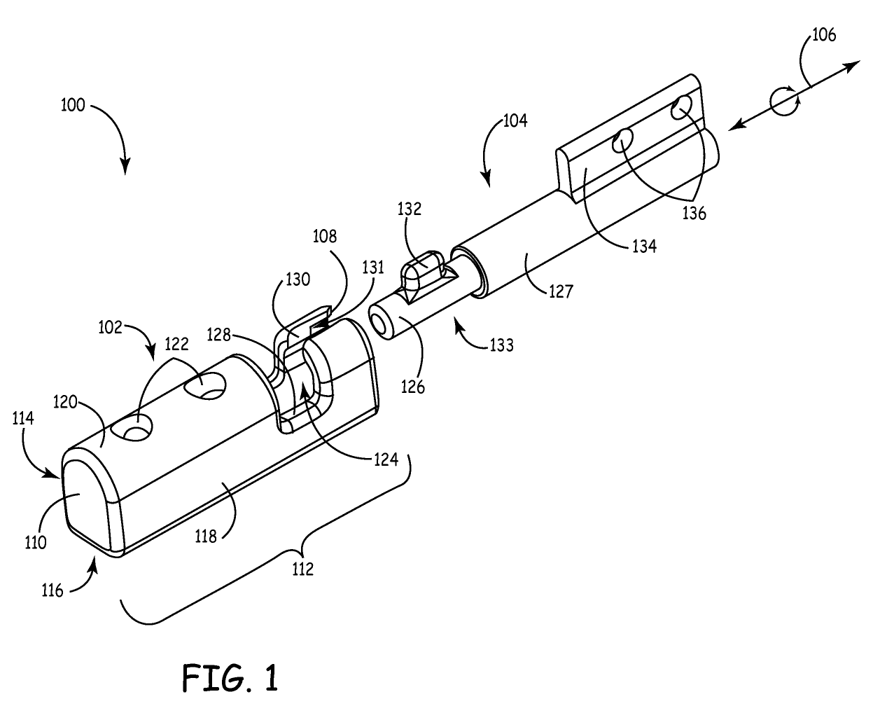

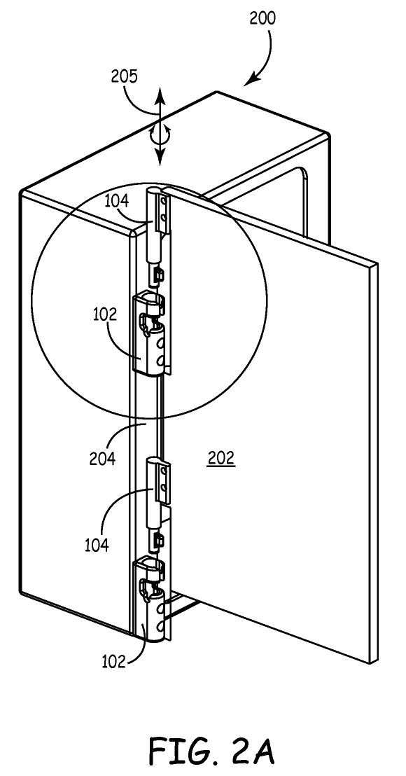

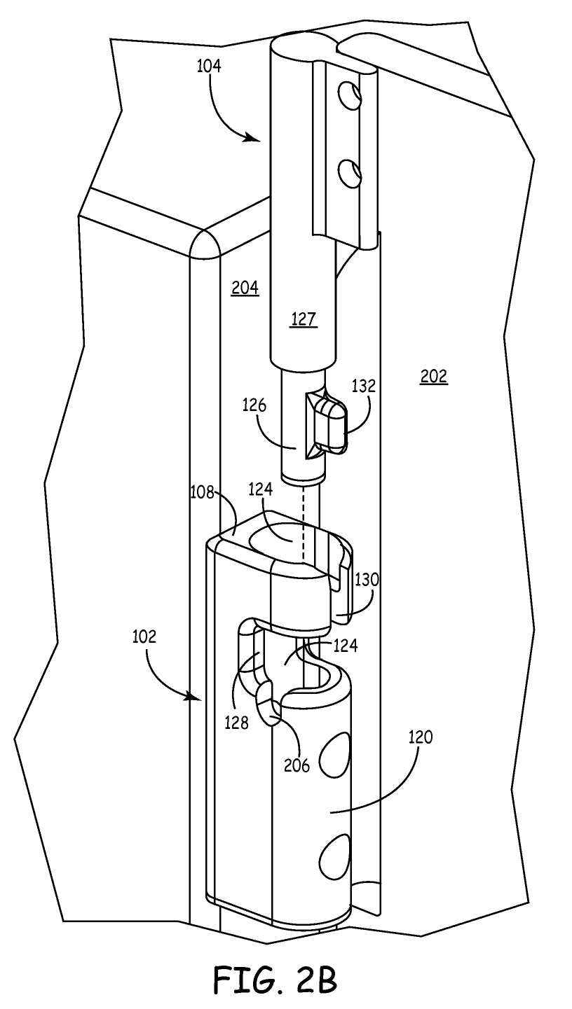

FIG. 1 illustrates a hinge 100 of one embodiment of the present invention that provides multiple functionalities. Hinge 100 has two components; a female body 102 and a male body 104. In this embodiment, female body 102 is a fixed component of hinge 100 for mounting on a frame (shown in FIGS. 2A, 2B, 3, 4, 5A, 5B, and 6) or other stationary structure. Male body 104 is a rotating component of hinge 100 for mounting to a door (shown in FIGS. 2-6) or other structure that pivots in relation to the frame. As described in greater detail below, male body 104 fits into female body 102. Once inserted, male body 104 is allowed to rotate about an axis of rotation, longitudinal axis 106, which is defined by male body 104.

As shown, female body 102 extends longitudinally parallel to longitudinal axis 106. Female body 102 has a first end 108, a second end 110, and a middle portion 112. As shown, first end 108 and second end 110 are substantially flat surfaces on the top and bottom of female body 102 respectively. Middle portion 112 is the area between first end 108 and second end 110. In this embodiment, middle portion 112 includes walls 114, 116, 118, 120. Three of the walls 114, 116, 118 have a generally flat and rectangular outer shape and the fourth wall 120 has rounded outside. As shown, fourth wall 120 is rounded, but wall 120 need not be so shaped. In other embodiments wall 120 is any shape that allows for free movement of a door attached to hinge 100.

As would be appreciated by one of ordinary skill in the art upon reading this specification, female body 102 can mount to a structure by any means known to those skilled in the art. As shown, side 120 includes two apertures 122 that provide access for securing wall 116 to a frame, via screws or bolts. In this embodiment, wall 116 also contains two apertures (not shown) through which the screws or bolts are inserted; however, other fastening members may be used. For example, in other embodiments, the fastening member is an adhesive between wall 116 and the frame or a weld connecting wall 116 to the frame.

Female body 102 includes a longitudinal cavity 124 oriented parallel to the longitudinal axis 106 and open at least to first end 108. This shape and orientation of longitudinal cavity 124 allows it to accept a cylindrical shaft 126 of male body 104, meaning that cylindrical shaft 126 can be inserted into cavity 124. Cavity 124 extends from first end 108 inward into female body 102. In this embodiment, cavity 124 also opens to middle portion 112 of female body 102 via a partially rotational slot 128.

Female body 102 also has a rotational slot 128 which extends around the middle portion 112 of female body 102 perpendicular to longitudinal axis 106. Rotational slot 128 guides the rotation of male body 104 within female body 102. As stated above, rotational slot 128 opens inward to cavity 124. Cavity 124 and rotational slot 128, therefore, connect forming a single void. Rotational slot 128 extends in an arc around the perimeter of the general cylinder formed by cavity 124. Also, rotational slot 128 is positioned in middle portion 112 of female body 102 and does not open to first end 108. Rotational slot 128 does not open to first end 108, because a portion of female body 102 located between rotational slot 128 and first end 108 holds a tab 132 (explained in greater detail below) of male body 104 in female body 102.

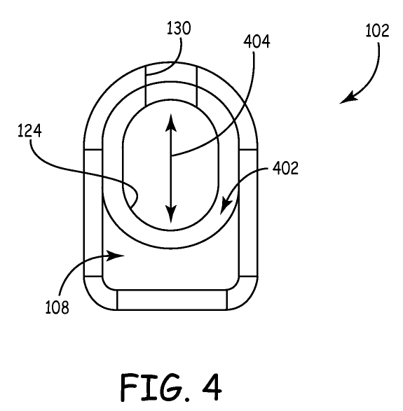

Female body 102 also has a longitudinal slot 130. Like rotational slot 128, longitudinal slot 130 opens inward to cavity 124. Longitudinal slot 130 also opens outward to middle portion 112 of female body 102. Longitudinal slot 130 extends parallel with longitudinal axis and from first end 108 of female body 102 to rotational slot 128. Longitudinal slot 130, therefore, forms a notch in the opening at first end 108 which is shown in further detail in FIG. 4. Longitudinal slot 128 is parallel to the angle of insertion/removal of male body 104 into/out of female body 102. Longitudinal slot 130 also connects to both cavity 124, and rotational slot 128, forming a single contiguous void amongst the three structures.

Although for this illustrative embodiment, rotational slot 128 and longitudinal slot 128 open outward to middle portion 112 of female body 102, the present invention is not intended to be so limited. For example, either rotational slot 128 or longitudinal slot 130 or both can be implemented as an inward opening slot (e.g. an inward groove) within female body 102. Thus, in the embodiment where both rotational slot 128 and longitudinal slot 130 open inward only, cavity 124 opens to the outside of female body 102 only at first end 108 of female body 102.

As mentioned above, male body 104 has a cylindrical shaft 126 that is sized and shaped for insertion into cavity 124 of female body 102. As shown, shaft 126 is sufficiently cylindrical to allow for smooth rotation of shaft 126 within cavity 124 of female body 102. For example, shaft 126 in one embodiment has a generally rounded shape that is made up of a plurality of smaller flat sides. Shaft 126 extends from a main portion 127 of male body 104. Similar to shaft 126, main portion 127 is cylindrical to aid smooth rotation of male body 104 within cavity 124 of female body 102. When male body 104 is inserted in female body 102 shaft 126 is completely contained within cavity 124 of female body 102. Main portion 127 of male body 104 is partially inserted into cavity 124. Although for this illustrative embodiment, main portion 127 of male body 104 is partially inserted into cavity 124, the present invention is not intended to be so limited. For example, in another embodiment, main portion 127 does not enter into cavity 124 and the shape of main portion 127 is square.

Male body 104 also has a tab 132 extending outward from a lateral portion of cylindrical shaft 126 as shown generally at 133. Tab 132 is fits through longitudinal slot 130 when shaft 126 is inserted into cavity 124 and tab 132 is aligned with longitudinal slot 130. Tab 132 restricts insertion and removal of shaft 126, because shaft 126 can only be inserted and removed when tab 132 is aligned with longitudinal slot 130. Tab 132 also fits through rotational slot 128 when shaft 126 is rotated within female body 124. As male body 104 rotates within female body 102, tab 132 slides within rotational slot 128. Tab 132 and the edges of rotational slot 128 combine to restrict the rotation of shaft 126 within cavity 124. At the extreme rotation in either direction, tab 132 comes into contact with an edge of rotational slot 128, preventing further rotation of shaft 126 and male body 104. Male body 104 also has a mounting tab 134 which has two apertures 136. Apertures 136 accept a bolt or a screw to mount male body 104 to a door or the like.

Notably, the geometries of female body 102 and male body 104 allow the components to be inexpensively manufactured. For example, in the illustrative embodiment shown in FIG. 1, male body 102 is completely die-castable, and female body 104 is die-castable with a sliding core insert. Additionally, in this embodiment, little or no post-process machining is necessary on either component.

In another embodiment of hinge 100, male body 104 is a fixed component and female body 102 is a rotating component that rotates about longitudinal axis 106. In this embodiment, male body 104 is mounted to a stationary frame with shaft 126 facing upwards. Likewise, female body 102 is mounted to a door or similar structure that is to move with respect to the frame and cavity 124 is positioned to be open downwards.

FIG. 2A illustrates one embodiment of two hinges 100 used on an enclosure 200. As shown, male bodies 104 are mounted to a door 202, and corresponding female bodies 102 are mounted to a frame 204 of enclosure 200. Alternatively, any number of hinge(s) 100 can be used to connect door 202 to frame 204. The number of hinges 100 can be selected based on the desired strength and/or the amount of weight to be supported by hinge(s) 100. For example, if door 202 is small and lightweight and is to be used in a non-abusive environment, one hinge 100 may be sufficient to support door 202. As shown in FIG. 2A, two female bodies 102 are mounted to frame 204 such that for each, cavity 124 is aligned with a desired rotational axis 205 for door 202. Likewise, two male bodies are mounted to door 202 and aligned with rotational axis 106. As shown, female bodies 102 are mounted vertically with the open end of cavity 126 facing upwards. Male bodies 104 are also mounted vertically and are positioned such that shaft 126 is pointed downwards for insertion into cavity 124. Cavity 124 is mounted in this way to ensure that gravity will hold door male body 102 into female body 104.

FIG. 2B shows a close-up view of hinge 100 and enclosure 200 of FIG. 2A. Hinge 100 allows door 202 to be easily and quickly connected to frame 204, while lessening the probability that door 202 will accidentally disconnect from frame 202. Tab 132 of male body 104 allows shaft 126 to be inserted and removed from cavity 124 only when tab 132 is aligned with longitudinal slot 130 as illustrated in FIG. 2B. In this embodiment, longitudinal slot 130 is positioned at 90 degrees relative to the face of frame 204. Tab 132 is positioned at 0 degrees relative to face of door 202. Thus, door 202 and male body 104 can be inserted and removed from frame 204 and female body 102 when door 202 is opened to 90 degrees as shown. Alternatively, hinge 100 can be designed to allow insertion or removal of door 202 at any angle to which door 202 can open. The desired angle of removal and insertion of door 202 is set by selecting the positioning of one or both of longitudinal slot 130 and tab 132. For example, door 202 is able to be removed and inserted when open to 180 degrees. In this embodiment, tab 132 is positioned at 0 degrees and longitudinal slot 130 is positioned at 180 degrees.

In the embodiment shown in FIG. 2B, longitudinal slot 130 has a width that is slightly larger than a width of tab 132. The width of tab 132 and longitudinal slot 130 are selected so that tab 132 has sufficient clearance to slide through longitudinal slot 132 when positioned at the correct angle, but tab 132 will not easily slide through slot accidentally. Alternatively, longitudinal slot 130 can be designed such that it is much larger than the width of tab 132. This allows added flexibility in the angle of removal and insertion male body 104, but also increases the likelihood of accidental disconnection of door 202. For example, in one embodiment, longitudinal slot 130 spans from 135 degrees to 180 degrees. In this alternative embodiment, male body 104 can be removed and inserted when door 202 is opened anywhere in the range from 135 to 180 degrees. The height of longitudinal slot 130 (i.e. distance from first end of female body 102 to rotational slot 128) is selected to ensure that there is enough structure from female body 102 above rotational slot 128 to support male body 104 with door 202 mounted thereto.

When male body 104 is inserted in female body 102, tab 132 comes into contact with the bottom edge of rotational slot 128, thus preventing further insertion of male body 102. When inserted tab 132 slides on the bottom edge of rotational slot 128 as shaft 126 rotates within cavity 124. Rotational slot 128 has a height of sufficient clearance to allow tab 132 to slide easily within rotational slot 128, while maintaining control of tab 132. Rotational slot 128 also determines the limits of the rotational movement of male body 104. When shaft 126 rotates far enough in either direction, tab 132 slides through rotational slot 128 and comes into contact with the ends of rotation slot 128.

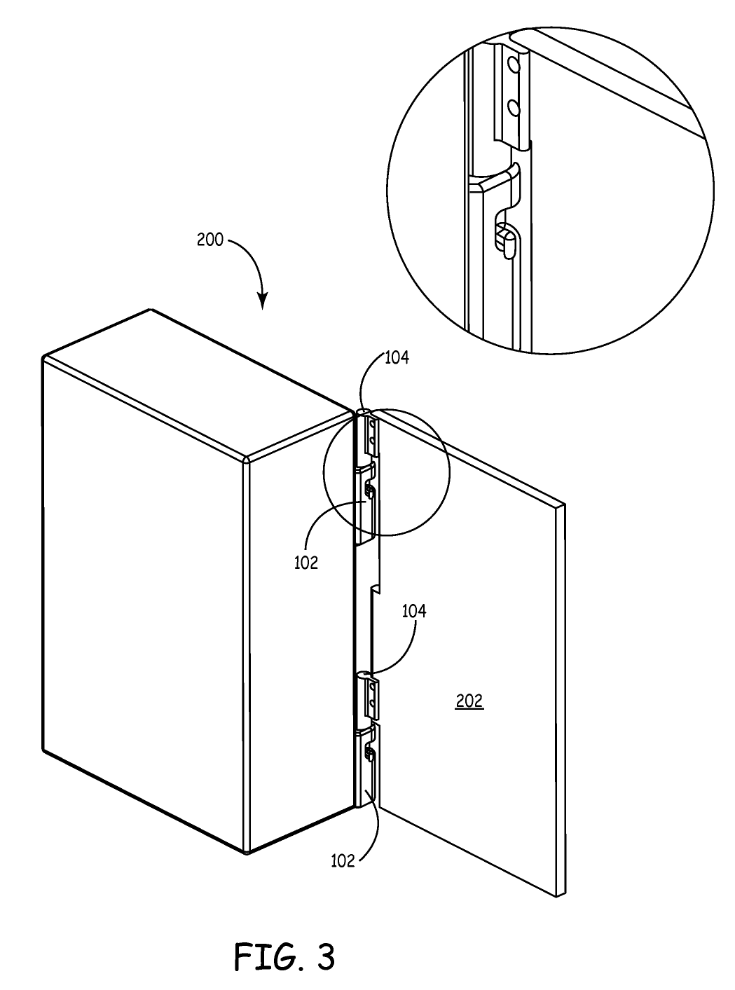

For example, in the embodiment shown in FIGS. 2A, 2B, and 3, rotational slot 128 spans from 0 degrees (relative to frame 204) to 180 degrees, and door 202 is allowed to rotate from completely closed, 0 degrees, to 180 degrees open. At 180 degrees open, tab 132 comes into contact with the edge of rotational slot 128 and door 202 is prevented from opening any further. In another example embodiment, rotational slot 128 spans from 0 degrees to 90 degrees, and door 202 is allowed to rotate from 0 to 90 degrees. Alternatively, the span of rotational slot 128 and the position of tab 132 could be selected to allow any amount of rotation of door 202. This is advantageous because, for example, it can prevent door 202 from rotating out of reach of an operator. Another advantage occurs if door 202 has components mounted upon it with cables running between the door mounted components and other components inside of frame. In this situation door 202 is limited in rotation to avoid overextending and damaging the cables.

In the embodiment shown in FIG. 2B, female body 102 also has a notch 206 in rotational slot 128. When door 202 is rotated and tab 132 falls into notch 206, notch 206 holds door 202 open in a stationary position as shown in FIG. 3. One of ordinary skill in the art upon studying this specification would appreciate that in alternate embodiments, additional notches such as notch 206 may be included in order to support holding door 202 in one of a plurality of predetermined positions. Referring then to FIG. 3, FIG. 3 illustrates one embodiment of hinge 100 open to 180 degrees with door 202 locked in notch 206. As shown tab 132 has dropped into notch 206, holding door 202 in this position. To remove tab 132 from notch and allow free rotation of door 202, door 202 is manually lifted until tab 132 slides out of notch 206, door 202 is rotated slightly, and tab 132 is rested on bottom surface of rotational slot 128. This is advantageous, for example, because an operator can open door 202, secure tab 132 in notch, and have both hands free to access components internal to enclosure 200 or perform other activity with minimal danger of door 202 rotating unintentionally. Notch 206 has a width that provides sufficient clearance to allow easy insertion and removal of tab 132, but snug enough on tab 132 so that door 202 is stationary when tab 132 is inserted into notch 206. Likewise, notch 206 is of a depth that tab 132 can easily slide in and out of notch 206, but will not unintentionally pop out of notch 206. In the embodiment shown in FIGS. 2A, 2B, and 3, notch 206 is positioned at 180 degrees relative to frame 204, however the present invention is not intended to be so limited. For example, notch 206 could be positioned at 90 degrees, or any other angle to hold door 202 at that angle as desired for the particular application. In another example, female body 102 could have multiple notches positioned at different rotational degrees to provide multiple rotational degree locations at which door 202 could be held open.

FIG. 4 illustrates a top perspective view of one embodiment of female body 102. Female body 102 has a lip 402 along the edge of cavity 124 which marks a change in size of cavity 124. The top portion (closest to first end 108) of cavity 124 is larger than the bottom portion of cavity 124. The large and small portions of cavity 124 correspond to the larger diameter main portion 127 and smaller diameter shaft 126 of male body 104. In this embodiment, the junction between main portion 127 and shaft 126 on male body 104 in not necessarily flush with lip 402 during normal rotation of male body 102 within female body. Instead the junction between main portion 127 and shaft 126 becomes flush with lip 402 only when tab 132 of male body 104 falls into notch 206. Although for this illustrative embodiment, the junction between main portion 127 and shaft 126 becomes flush with lip 402 only when it falls into notch 206, the present invention is not intended to be so limited. For example, in another embodiment, the junction between main portion 127 and shaft 126 rides on lip 402 during normal rotation of male body 104 and female body 102 does not have a notch 206. In yet another embodiment, the junction between main portion 127 and shaft 126 does not become flush with lip 402 at all. In still another embodiment, cavity 124 does not have a lip, and the junction between main portion 127 and shaft 126 rides on first end 108 of female body. In yet another embodiment, cavity 124 does not have a lip, and there is no difference in diameter between main portion 127 and shaft 126 of male body 104.

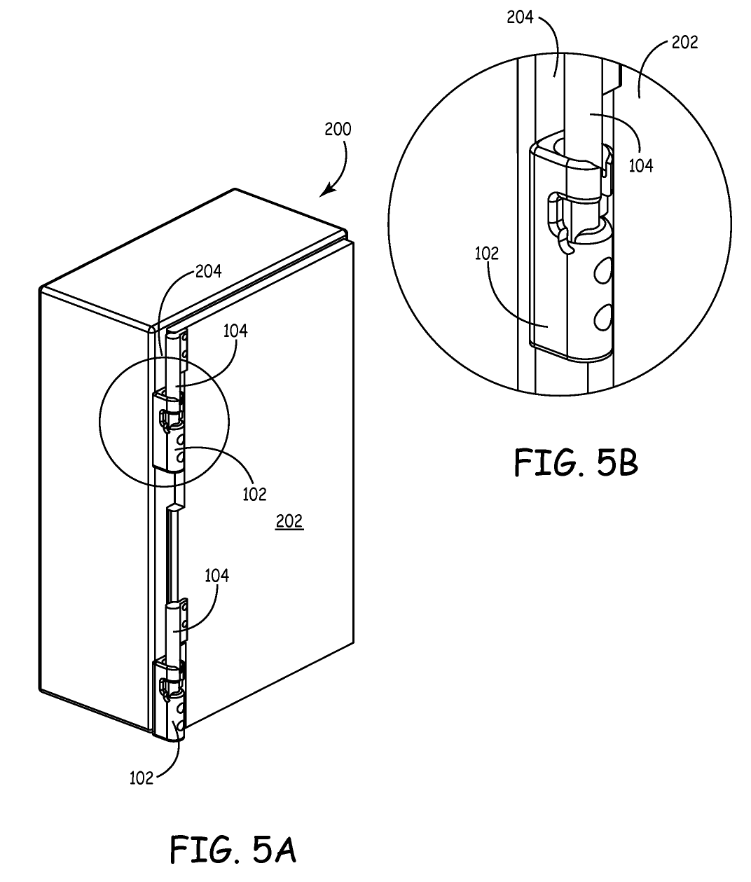

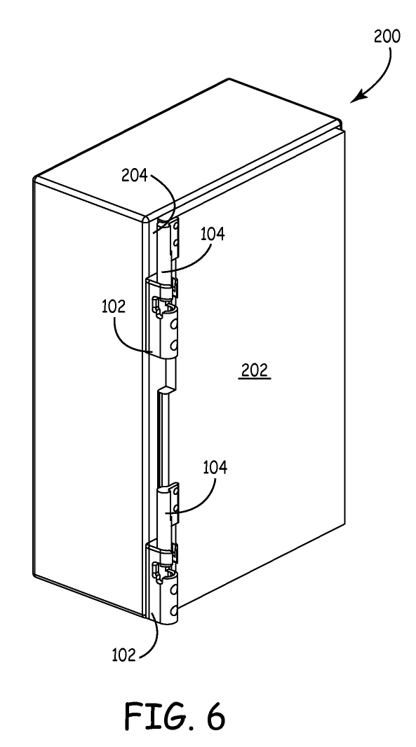

In addition to rotational movement, hinge 100 allows translational movement of door 202. As shown, cross-section of cavity 124 is oversized relative to shaft 126 to allow shaft 126 to slide translationally along line 404 (normal to frame 202 and longitudinal axis 106) within cavity 124. In this embodiment, longitudinal cavity 124 has an elongated cross section which allows shaft 126 to move translationally along line 404, while restricting translational movement in other directions. Additionally, cavity 124 is elliptical to allow for smooth rotation of shaft 126 within cavity 124. Both the upper (larger) portion of cavity 124 and the lower (smaller) portion of cavity 124 are elliptic shape. Three-dimensionally, cavity 124 forms one larger elliptic cylinder (upper portion) on top of a smaller elliptic cylinder (lower portion). Further, the longer diameters of each elliptic cross-section are aligned along line 404. The cross-sectional widths of lower and upper portions of cavity 124 (perpendicular to line 404) correspond to the diameters of shaft 126 and main portion 127 respectively, limiting movement in the direction perpendicular to line 404. The cross-sectional lengths of lower and upper portions of cavity 124, however, are larger than the diameters of shaft 126 and main portion 127 respectively. Thus, shaft 126 and main portion 127 are allowed to move along line 404 while inserted in cavity 124. In this embodiment, the cross-sections lower and upper portion of cavity 124 are approximately the diameter of shaft 126 and main portion 127 respectively, plus the width of an o-ring used to seal an attached door to an attached frame. More detail with respect to the o-ring is provided with respect to FIGS. 5 and 6.

Although for this illustrative embodiment, the cross-section of cavity 124 is shown as having an elliptic shape, the present invention is not intended to be so limited. For example, in another embodiment, the cross-section of cavity 124 is circular and has a lower and upper portion diameter that is significantly larger than shaft 126 and main portion 127 respectively. This allows shaft 126 and main portion 127 to move translationally in multiple directions, including in direction 404. Alternatively, cavity 124 could be any shape that allows both rotation of shaft 126 and translational movement in the direction of line 404.

FIGS. 5A and 5B illustrate one embodiment of door 202 in its closed and unlatched position. In this embodiment enclosure 200 has one or more latches (not shown) that press and hold door 202 against frame 204. The latch(es) apply pressure upon door 202, thereby compressing an o-ring placed between door 202 and frame 204 to form a tight seal. There are many types of latches and any type can be used as is know by those skilled in the art. FIG. 5B illustrates a close-up view of hinge 100 when door 202 is in the closed and unlatched position. Here, male body 104 is positioned at 0 degrees rotation within female body 102. Door 202 is unlatched, thus allowing male body 104 and door 202 to move translationally outward from frame 204. This removes the pressure on an o-ring or gasket between door 202 and frame 204. Door 202 can be slide outward manually, or can naturally slide outward from the force of the compressed o-ring or gasket decompressing.

The elliptic shape of cavity 124 allows for the translational movement of shaft 126 within cavity 124. Consequently, when door 202 is unlatched a slight gap is formed between door 202 and frame 204 before door 202 is rotated open. This is advantageous, for example, because the o-ring or gasket between door 202 and frame 204 will be less likely to be damaged from contact between door 202 and frame 204. The translation movement, therefore, reduces the damage to and prolongs the life of the o-ring or gasket.

FIG. 6 illustrates one embodiment of door 202 closed and latched shut. Latch 502 places inward force against door, sliding male body 104 translationally within cavity 124 of female body 102. Male body 104 is allowed to slide until shaft 126 comes into contact with interior side of cavity 124. Latch 502 forces door 202 against an o-ring between door 202 and frame 204, thereby squishing the o-ring and creating a tight seal between door 202 and frame 204. In one embodiment, door 202 slides fully inward until male body 104 contacts interior side of cavity 124. In another embodiment, door 202 slides partially inward in cavity 124 until the resistant force of o-ring equalizes the force of the latch. Sliding door 202 translationally inward against frame 204 and o-ring provides a more even pressure distribution against the o-ring and frame 204 as compared to pivoting of door 202 against frame 204.

Along with even pressure distribution, the translational movement of door 202 reduces damage to o-ring when pivoting door 202 open and closed. When latch 502 is released, the compression on the o-ring is relieved and door 202 is allowed to slide outward from frame 204. Thus, when door 202 is pivoted open and closed, there is little or not contact between door 202 and the o-ring, minimizing damage to the o-ring.

In one embodiment, both male body 104 and female body 102 are composed of metal, and more specifically aluminum. In this embodiment, female body 102 has a steel insert to provide added resistance to wear from rotation of male body 104. As known to those skilled in the art, in other embodiments, either male body 102, female body 104, or both could be composed entirely or partially of steel, plastic, a composite, or other material possessing the strength and rigidity for the particular application.

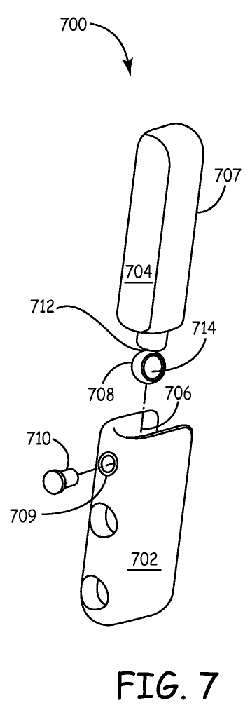

FIG. 7 illustrates another embodiment of a hinge 700 of one embodiment of the present invention. Hinge 700 has a female body 702 and a male body 704. Female body 702 has an elliptic cavity 706 configured to accept a shaft 708 of male body 704. Shaft 708 of male body extends from main portion 707 of male body 704. Female body 702 also has an aperture 709 for accepting a set screw 710 to hold shaft 708 into cavity 706 of female body 702. To use set screw 710 shaft 708 of male body is inserted into cavity 706 and set screw 710 is inserted into female body 702 so that screw intrudes into a groove 712 formed in shaft 708. Groove 712 is located between the end of shaft 710 and main portion 707. As male body 704 is rotated, set screw 710 slides in groove 712. As shown, the end of shaft 708 is rounded partially rounded to prevent removal of shaft 708 from cavity 710 when rounded area is facing set screw 710. The end of shaft 708 also has a flat face 714 which allows shaft 708 to be removed from cavity 710 when shaft 708 is rotated so that flat face 714 aligns with set screw 710. Thus, with set screw 710 installed hinge 700 allows insertion and removal of male body 704 only when male body 704 and associated door are rotated to the proper angle. Further, cavity 706 is elliptic which allows shaft 708 to move translationally within cavity 706. As discussed prior, this can be used to relieve pressure from a gasket or o-ring used to seal a door to a frame.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A hinge comprising:
a first body having:
a cylindrical shaft; and
a tab extending from a lateral portion of the cylindrical shaft; and
a second body having a first end, a second end, and a middle portion between the first end and the second end, the second body defining:
a longitudinal cavity open to the first end and extending into the second body, the longitudinal cavity configured to accept the cylindrical shaft of the first body and having an oversized cross-section relative to the cylindrical shaft;
a rotational slot in the middle portion of the second body extending partially around a lateral side of the longitudinal cavity and open to the longitudinal cavity, the rotational slot configured to allow the tab of the first body to fit therethrough when the first body is rotated; and
a longitudinal slot extending from the first end of the second body to the rotational slot and open to the longitudinal cavity, the longitudinal slot configured to allow the tab of the first body to fit therethrough.

2. The hinge of claim 1, wherein the first body further comprises:
a main portion having a width that is larger than a diameter of the cylindrical shaft, wherein the cylindrical shaft extends from the main portion.

3. The hinge of claim 1, wherein the longitudinal cavity of the second body further comprises:
a first portion extending from the first end of the second body; and
a second portion abutting the first portion and extending into the longitudinal cavity, wherein the first portion is wider than the second portion.

4. The hinge of claim 1, wherein the rotational slot further comprises:
at least one notch configured to accept the tab of the first body and hold the first body in a stationary position.

5. The hinge of claim 4, wherein a first notch of the at least one notch is positioned at an angle in the range of 90 to 270 degrees relative to a frame opening.

6. The hinge of claim 1, wherein the rotational slot spans from 0 degrees to an angle in the range from 90 to 270 degrees.

7. The hinge of claim 1, wherein the longitudinal cavity has an elongated cross-section.

8. The hinge of claim 7, wherein the longitudinal slot is positioned at an angle in the range of 45-180 degrees.

9. The hinge of claim 1, wherein the longitudinal slot spans from 135 to 180 degrees in width.

10. The hinge of claim 1, wherein the rotational slot is an inward opening groove.

11. The hinge of claim 1, wherein the longitudinal slot is an inward opening groove.

12. A device for coupling a panel relative to a frame, the device comprising:
a first body including an elongated cylindrical cavity; and
a second body including a shaft, and having a tab extending from a lateral portion the shaft, the shaft having an axis of rotation about the center of the shaft;
wherein the first body is configured to accept insertion of the shaft of the second body into the elongated cylindrical cavity and further configured to allow movement of the second body about the axis of rotation; and
the first body further including a slot connected to the elongated cylindrical cavity and configured to allow the tab of the second body to slide therethrough when the second body is rotated.

13. The device of claim 12, wherein the first body further comprises:
at least one notch configured to accept the tab and hold the second body in a stationary position.

14. The device of claim 13, wherein the at least one notch includes a first notch positioned at 180 degrees relative to a frame opening.

15. The device of claim 11, wherein the second body further comprises:
a main portion that is larger than the shaft, wherein the shaft extends from the main portion.

16. The device of claim 11, wherein the slot is positioned at 90 degrees relative to a frame opening.

17. The device of claim 11, wherein the slot is positioned at 180 degrees.

18. A hinge comprising:
a first body having a first end, a second end, and a middle portion between the first end and the second end, the first body defining:
a longitudinal cavity open to the first end and extending into the first body, the longitudinal cavity configured to accept a shaft of a second body and allow rotation of the shaft and translation of the shaft normal to the rotation;
a rotational slot in the middle portion of the first body extending partially around a lateral side of the longitudinal cavity and open to the longitudinal cavity, the rotational slot configured to allow the tab of the second body to fit therethrough when the second body is rotated; and
a longitudinal slot extending from the first end of the first body to the rotational slot and open to the longitudinal cavity, the longitudinal slot configured to allow the tab of the second body to fit therethrough.

19. The hinge of claim 18, wherein the longitudinal cavity has an elongated cross-section.

20. The hinge of claim 18, wherein the longitudinal cavity has a circular cross-section.

21. The hinge of claim 18, further comprising:
a second body having a shaft inserted into the elongated cylindrical cavity of the first body, the shaft having an axis of rotation about the center of the shaft, the second body having a tab extending from a lateral portion the shaft.

22. A hinge comprising:
a first body comprising;
a main portion; and
a shaft extending from the main portion, the shaft comprising:
a partially rounded end having a flat face; and
a circumferential groove between the partially rounded end and the main portion; and
a second body comprising:
an elongated cavity extending into the second body and configured to allow insertion of the shaft of the first body; and
a fastener penetrating the second body into the elongated cavity, the fastener configured to at least partially insert into the circumferential groove of the shaft when the shaft is inserted into the elongated cavity; and
wherein the shaft is removable from the elongated cavity when the flat face is aligned with the fastener.

23. The fastener of claim 22, wherein the fastener is a set screw.
